(19) United States
(12) Patent Application Publication
(10) Pub. No.: US 2025/0337213 A1
(43) Pub. Date: Oct. 30, 2025

(54) Improved Depolarization Mitigation Method and Apparatus

(71) Applicants: Alexander Lee LOVESEE, Albuquerque, NM (US); Ting Shan LUK, Albuquerque, NM (US); Dustin Theodore OFFERMANN, Santa Fe, NM (US); Trevor Abraham RUBIN, Albuquerque, NM (US); Donald Edward VOSS, Albuquerque, NM (US)

(72) Inventors: Alexander Lee LOVESEE, Albuquerque, NM (US); Ting Shan LUK, Albuquerque, NM (US); Dustin Theodore OFFERMANN, Santa Fe, NM (US); Trevor Abraham RUBIN, Albuquerque, NM (US); Donald Edward VOSS, Albuquerque, NM (US)

(21) Appl. No.: 18/648,368

(22) Filed: Apr. 27, 2024

(51) Int. Cl. H01S 3/08; H01S 3/06; H01S 3/13

(52) U.S. Cl. CPC H01S 3/08072; H01S 3/08054; H01S 3/1308; H01S 3/061

(57) ABSTRACT

A method is presented for mitigation of thermal depolarization in laser systems, which uses a spatially variable 180 degree phase retarder to transition the native uniformly linear polarization of the laser to a spatially dependent polarization pattern which matches the birefringence of the gain media prior to the beam encountering the gain media. A second phase retarder converts the polarization back to uniform linear after the beam exits the gain media. The invention includes two phase retarder apparatus which consist of nano-structured, meta-surfaces etched into a monolithic glass optic. The meta-surfaces are designed to provide the required phase retardance pattern as well as an anti-reflective property negating the need for additional coatings and increasing the power handling capability of the optic.

### GOVERNMENT INTEREST

This invention was made with Government support under Grant No. DE-SC0021856 awarded by the U.S. Department of Energy to Voss Scientific, LLC entitled “Novel Approaches to Eliminating Thermally Induced Birefringence in High Average-Power Laser Amplifiers.” The Government has certain rights in this invention.

### BACKGROUND

The presently claimed invention relates to a method and apparatus associated with the field of solid-state laser technology and generally related to thermally induced distortions in lasers. More specifically, the presently claimed invention relates to the mitigation of depolarization caused by thermally induced birefringence in laser gain media. This invention also relates to a nano-structured meta-surface optic, which provides spatially dependent phase retardance used to overcome distortions caused by thermal birefringence. The presently claimed invention includes a nano-structured, meta-surface that is inherently anti-reflective, the meta-surface is patterned to produce the required spatial variation in phase retardance to convert linear to radially or tangentially polarized light. The glass material used in the invention efficiently transmits the high intensity laser light without damage and with minimal absorption, the high selectivity mask manufacturing method used to produce the nano-structure will generate a sufficient aspect ratio to produce the required 180 degree retardance in a high damage threshold laser glass.

Lasers with modest to high average power suffer from a distortion effect known as thermal depolarization. This effect as well as a previous method to correct it is described in detail in (European patent application no. 20159334.0, EP3712664A1, dated 25 Feb. 2020, “Depolarization Compensator”, Andrejus Michailovas, 22 pages). The depolarization compensator described is extremely limiting in that each device is designed to correct a specific laser configuration and any significant change to the laser design or operating parameters would greatly reduce the effectiveness of the compensator. In addition, the proposed use of an ultrafast laser to directly write the spatially variable birefringence is expensive, and impractical for larger optics or shorter wavelengths.

The presently claimed invention uses a spatially variant phase retarder to align the laser polarization with one of the axes of the thermal birefringence. The phase retarder is manufactured using nano-fabrication similar to that discussed in previous work (Uriel Levy, Chia-Ho Tsai, Lin Pang, and Yeshaiahu Fainman, “Engineering space-variant inhomogeneous media for polarization control”, Optics Letters, Vol. 29, No. 15, Aug. 1, 2004). This publication demonstrated a meta-surface optic manufactured in the high refractive index material, GaAs (n=3.13). This material is highly absorptive to near infrared and visible wavelengths precluding it's use for lasers of this type. Materials with a high index of refraction that are transmissive to shorter wavelengths have been shown to be damaged when subjected to the peak optical intensities typical of the laser systems for which this invention is intended. In addition, the high index of refraction of GaAs allows the 180 degree phase retardance to be achieved with a height to width aspect ratio of only 3. The lower index of refraction of the glass material in the presently disclosed invention requires a much higher aspect ratio. Finally, the reported device was made using a standard microfabrication process: electron-beam mask, photo lithography, chemically assisted ion-beam etching. This type of process cannot produce the aspect ratio required to achieve the desire retardance in low index glass.

To realize the high aspect ratio required for the presently disclosed invention, the optical substrate must be subjected to substantially greater etching than in previous work, typical photo lithographic mask materials cannot withstand the enhanced etching needed. In U.S. Pat. No. 11,815,668B2, a method of depositing dielectric meta-surfaces on a glass substate has been previously described (U.S. Pat. No. 11,815,668B2, dated 14 Nov. 2023, “Atomic Layer Deposition Process for Fabricating Dielectric Metasurfaces for Wavelengths in the Visible Spectrum” Robert C. Devlin, Mohammadreza Khorasaninejad, Frederico Capasso, Hongkun Park, Alexander Arthur High. 26 pages). This method demonstrates the deposition of a dielectric nano-structured pattern on a glass substrate. In provisional U.S. patent application 63/636, 152 (Provisional U.S. Patent Application 63/636,152, dated 19 Apr. 2024, “Damascene Process for High Aspect Ratio Hard Mask”, Chloe F. Doiron et al.), it was further demonstrated that this dielectric pattern could be used as a high selectivity mask to enable the etching of high aspect ratio structures in the glass substrate.

Other researchers have demonstrated the antireflective properties achievable with nano-structured meta-surfaces (Yi Fan Huanga, Surojit Chattopadhyay, “Nanostructure surface design for broadband and angle-independent antireflection”, Journal of Nanophotonics, Vol. 7, Issue 01, April 2013) and (Xin Ye, Jin Huang, Feng Geng, Laixi Sun, Hongjie Liu, Xiaodong Jiang, Weidong Wu, Xiaotao Zu, Wanguo Zheng, “Broadband Antireflection Subwavelength Structures on Fused Silica Using Lower Temperatures Normal Atmosphere Thermal Dewetted Au Nanopatterns”, IEEE Photonics Journal, Volume 8, Number 1, February 2016). The maximum aspect ratio examined in this previous work was 5:1. Substantially higher aspect ratio structures are required to realize the 180 degree phase retardance required in optical glass. Structures of this type have been shown to reduce surface reflection properties in simulations.

### SUMMARY OF THE INVENTION

The presently claimed invention includes a method and apparatus for mitigation of thermal birefringence in laser systems using two spatially variable phase retarders to align the polarization of the laser with one of the principal axes of the thermal birefringence of the laser gain media. Laser systems using gain media which exhibits no natural birefringence suffer from depolarization caused by thermal gradients in the gain media which lead to a stress related birefringence. Since the axes of the birefringence are not uniform and do not align with the linear polarization of the laser light, the polarization of the laser light is altered in a non-uniform pattern. Many laser systems and applications depend on linear polarization and this distortion results in loss of laser power and significant degradation of the laser output beam profile. Various techniques have been employed to compensate for this effect, most recently a technique to correct the distortion was described (European patent application no. 20159334.0, EP3712664A1, dated 25 Feb. 2020, “Depolarization Compensator”, Andrejus Michailovas, 22 pages). In this invention, a custom designed and manufactured compensator optic is described, which has a spatially varying phase retardance that exactly counteracts that imposed by the gain media. This approach requires a custom optic specifically designed for each laser configuration, and even small changes in the laser parameters will significantly degrade the effectiveness of the compensation. The presently claimed invention solves the thermal birefringence problem by aligning the polarization of the laser light parallel to one of the principal axes of the thermal birefringence, eliminating the interaction of the laser with the second axis and the resulting distorting effects. A second identical optic placed after the gain media converts the polarization back to the original linear state allowing the remainder of the laser design to remain unchanged. This approach is more universal in its application than the aforementioned compensator. One embodiment of the present invention relates to a cylindrically shaped gain media where optical pump energy is incident from the outside diameter of the cylinder, and excess heat is extracted at the same surface. In this case the axes of the thermal birefringence are oriented in the radial and tangential directions.

The spatially variant phase retarder for this embodiment would convert the incident linear polarization into either radial or tangential to align with the birefringent axes of the cylindrical gain media. A phase retarder of this type can be used in any laser with a radially pumped, cylindrical gain media, of the same wavelength. In addition, changing the laser parameters such as pump power, repetition rate, pulse width, etc. would not reduce the effectiveness of this invention.

In some embodiments of the present invention, the spatially variable phase retarders consist of a nano-structured meta-surface etched into one or both sides of a monolithic substrate using a hard mask created with the Damascene method. Other methods have been used to create similar phase retarders, for example, direct writing with ultra short pulsed lasers was given as the method to create birefringent structures in glass substrates (European patent application no. 20159334.0, EP3712664A1, dated 25 Feb. 2020, “Depolarization Compensator”, Andrejus Michailovas, 22 pages). This technique has been detailed by various researchers (Gholamreza Shayeganrad, Xin Chang, Huijun Wang, Chun Deng, Yuhao Lei, and Peter G. Kazansky, “High damage threshold birefringent elements produced by ultrafast laser nanostructuring in silica glass”, Optics Express, vol. 30, No. 22/24, October 2022) and (L. Sudrie, M. Franco, B. Prade, A. Mysyrowicz, “Writing of permanent birefringent microlayers in bulk fused silica with femtosecond laser pulses”, Optics Communications 171, 1 Dec. 1999, pg 279-284). The fabrication of optics using this technique requires writing the pattern in each optic one point at a time with typical linear writing speeds of less than 0.1 mm/s. This process makes the cost of these optics prohibitively high for a larger sizes, and quantities. The nano-lithography techniques used to create meta-material surfaces is similar to that used in the fabrication of integrated electronic components, which has demonstrated very low costs when fabricated in significant quantities.

In some embodiments, the substrate used is a high damage threshold glass, such as fused silica, SiO₂.

In some embodiments, the meta-surface is formed by etching the pattern directly into the glass substrate, forming a monolithic structure. The required height to width aspect ratio is created using a high selectivity mask applied with Atomic Layer Deposition (ALD) (U.S. Pat. No. 11,815,668B2, dated 14 Nov. 2023, “Atomic Layer Deposition Process for Fabricating Dielectric Metasurfaces for Wavelengths in the Visible Spectrum” Robert C. Devlin, Mohammadreza Khorasaninejad, Frederico Capasso, Hongkun Park, Alexander Arthur High. 26 pages). In this patent, a dielectric structure is added to a glass substrate to create a meta-surface on the substrate to form an optic transmissive to visible light. In the presently described invention, the dielectric structure is added to the substrate using the same process, but for a different purpose. The dielectric structure is formed of a material which is highly resistant to plasma etching, forming a patterned mask which offers higher etching selectivity than traditional resist coatings. This technique has been shown to produce very high aspect ratio structures (Provisional U.S. Patent Application 63/636,152, dated 19 Apr. 2024, “Damascene Process for High Aspect Ratio Hard Mask”, Chloe F. Doiron et al.).

In some embodiments, the dielectric structure formed using ALD is Aluminum Oxide, Al₂O₃.

In some embodiments, the structure of the formed meta-surface consists of pattern of ridges and valleys, referred to as subwavelength gratings, or just gratings.

In some embodiments, the aspect ratio and structure of the meta-surface gratings produces a 180 degree phase retardance between the parallel and perpendicular components of the incident laser light. The orientation of the gratings is varied as a function of position to alter the polarization of light which is transmitted through the optic. The ability to design and fabricate a grating structure to produce a desired polarization pattern has been previously demonstrated (Uriel Levy, Chia-Ho Tsai, Lin Pang, and Yeshaiahu Fainman, “Engineering space-variant inhomogeneous media for polarization control”, Optics Letters, Vol. 29, No. 15, Aug. 1, 2004) and (Avi Niv, Gabriel Biener, Vladimir Kleiner, and Erez Hasman, “Formation of linearly polarized light with axial symmetry by use of space-variant subwavelength gratings”, Optics Letters, Vol. 28, No. 7/Apr. 1, 2003) using materials with a higher index of refraction. The higher index allows the 180 degree phase retardance to be realized with aspect ratios of 3:1 or less. The Laser Induced Damage Threshold (LIDT) for the materials used in these examples is a fraction of what is required for use internal to a typical laser cavity. High LIDT materials exhibit an index of refraction that is substantially lower, requiring the higher aspect ratios of the presently described invention.

In some embodiments of the invention, the shape and aspect ratio of the ridges is designed to reduce the fraction of incident laser light that is reflected. In previous work, nano-structures have been shown to effectively reduce surface reflections (Yi Fan Huanga, Surojit Chattopadhyay, “Nanostructure surface design for broadband and angle-independent antireflection”, Journal of Nanophotonics, Vol. 7, Issue 01, April 2013) and (Xin Ye, Jin Huang, Feng Geng, Laixi Sun, Hongjie Liu, Xiaodong Jiang, Weidong Wu, Xiaotao Zu, Wanguo Zheng, “Broadband Antireflection Subwavelength Structures on Fused Silica Using Lower Temperatures Normal Atmosphere Thermal Dewetted Au Nanopatterns”, IEEE Photonics Journal, Volume 8,Number 1, February 2016). The included examples are rod/cone shaped structures created specifically for this purpose. In the presently described invention, the meta-surface will be designed to also provide an anti-reflective (AR) property to the surface of the spatially variable phase retarder, eliminating the need for additional multilayer AR coatings as required for the invention described in European patent application EP3712664A1 (European patent application no. 20159334.0, EP3712664A1, dated 25 Feb. 2020, “Depolarization Compensator”, Andrejus Michailovas, 22 pages).

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Cross section of laser gain media showing the source of thermal birefringence.

FIG. 2. Effect of thermal birefringence on laser polarization and beam profile.

FIG. 3. Spatially variable retarder and effect on polarization.

FIG. 4. Implementation of thermal depolarization method and apparatus and resulting beam profile.

FIG. 5. Meta-surface fabrication showing a cross section of the structure with the Al₂O₃ high selectivity mask and the final result of high aspect ratio ridges.

FIG. 6. Ridge pattern design for one embodiment of the spatially variant phase retarder to convert linear to radial polarization.

FIG. 7. Detail design of ridges to realize anti-reflective property based on theory and modeling.

### DETAILED DESCRIPTION OF THE INVENTION

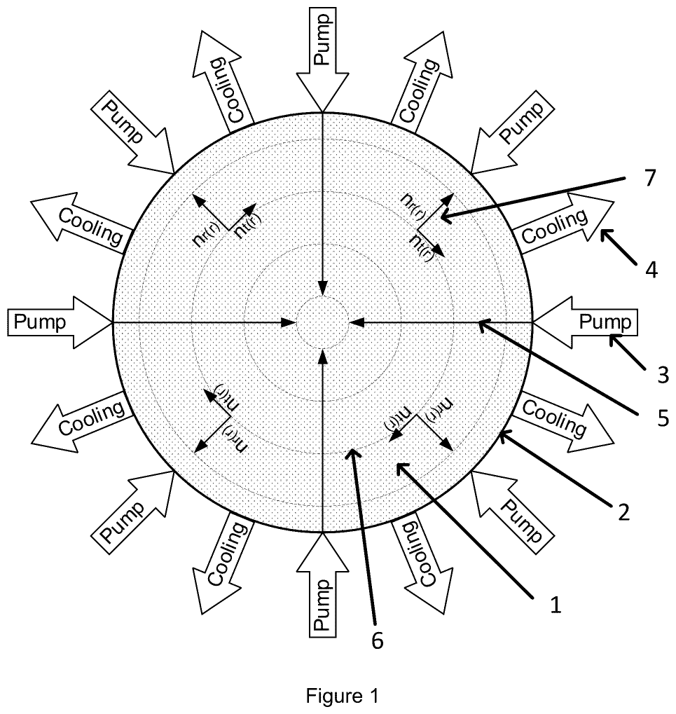

Laser systems with modest to high average power capability suffer from a type of optical distortion referred to as thermal depolarization. This effect reduces the maximum output power and causes significant distortion to the beam profile. The cause of this distortion is thermal birefringence in the laser gain media. One example of this is shown in FIG. 1, which is a cross section of a cylindrical laser rod that is pumped and cooled at the outside diameter. Other geometries of the gain media, such as a solid rectangular slab, also suffer from this effect and can be corrected with a specific embodiment of the presently claimed invention. In FIG. 1. the cross section of the laser rod is shown (1) the light (3) which pumps the gain media to an excited state is shown incident to the outer surface (2) of the rod. The energy from the pump is deposited uniformly across the rod diameter. The residual heat from the pump light is extracted at this same surface through a cooling mechanism (4). The result of the heating and cooling configuration is a thermal gradient (5) with increasing temperature from the outer surface of the rod (2) to the center. The uniform heating cooling creates circles of constant temperature (6). The internal stress caused by the temperature gradient results in material becoming birefringent due to the photoelastic effect. The axes of the birefringence are oriented in the radial and tangential directions (7), with the radial component being the slow axis and the tangential being the fast axis.

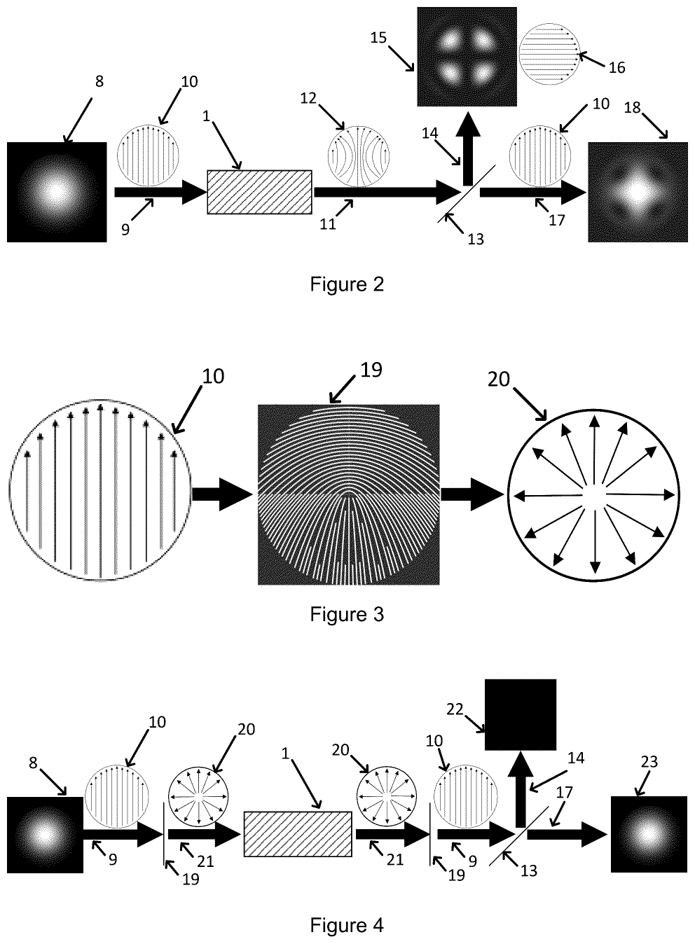

The effect of the thermal birefringence is shown in FIG. 2. Starting with a radially symmetric beam profile (8) with a linear polarization (10) which in this example is p polarized, the beam propagates (9) into the thermally birefringent laser rod (1). When the beam exits the rod (11) the polarization is distorted (12), with the degree and pattern of the distortion depending on the magnitude of the birefringence. The pattern shown is not meant to represent the actual polarization, as it is not simply a spatially variable linear polarization, but is in general elliptically polarized to varying degrees.

When the distorted polarization encounters a linearly polarizing element, shown here as a polarizing beam splitter (13) it is separated into two beams (14,17). The beam (17) which passes through the polarizer (13) is the p polarized component (10) of the distorted beam, and the reflected beam (14) is the s polarized component (16). A typical beam profile for the p component (18) shows a cross shaped profile with the significant loss in the four quadrants of the beam, while the s component profile (15) contains the missing energy showing light in only four quadrants. This example shows the effect of a modest level of birefringence, as the thermal gradient in the rod increases, the beam profiles become increasing complicated, with rings of the quadrant structure.

The presently described inventions is intended to prevent the depolarization from occurring by aligning the incoming beam polarization to one of the birefringent axes of the thermally stressed laser gain media. Continuing with the cylindrical rod embodiment of the invention, FIG. 3 shows the desired conversion. The uniformly linear p polarized input light (10) passes through a spatially variant 180 degree phase retarder (19). The phase retarder is designed to rotate the polarization of the linear input to match the thermal birefringent pattern of the gain media. In this example the retarder converts the p polarization to a spatially variant linear polarization with a radial orientation (20). Note that the same phase retarder will convert the radial polarization back to uniform, linear, p polarization.

One embodiment of the use of this method and apparatus is depicted in FIG. 4. Just as shown in FIG. 2, the system begins with a radially symmetric input profile (8) with p polarization (10). The beam (9) then encounters the spatially variable phase retarder (19) wherein it is converted to radially oriented linear polarization (20). The beam then continues (21) into the thermally stressed gain media (1). In this case, since the polarization (20) is aligned with only one axis of the thermal birefringence (FIG. 1, (7)) there is no change in the polarization, and it emerges from the rod (21) maintaining the same radially aligned linear polarization (20). The beam (21) then encounters a second spatially variable phase retarder (19), of the same type, wherein it is converted back to the original p polarization (10). The p polarized beam continues (9) into the polarizing beam splitter (13) where the full beam is passed on (17) containing nearly all of the laser energy in a radially symmetric profile (23). Only the portion of the light which is not correctly converted by the phase retarder (19) is reflected by the polarizer (13), this represents a very small fraction of the total power (22).

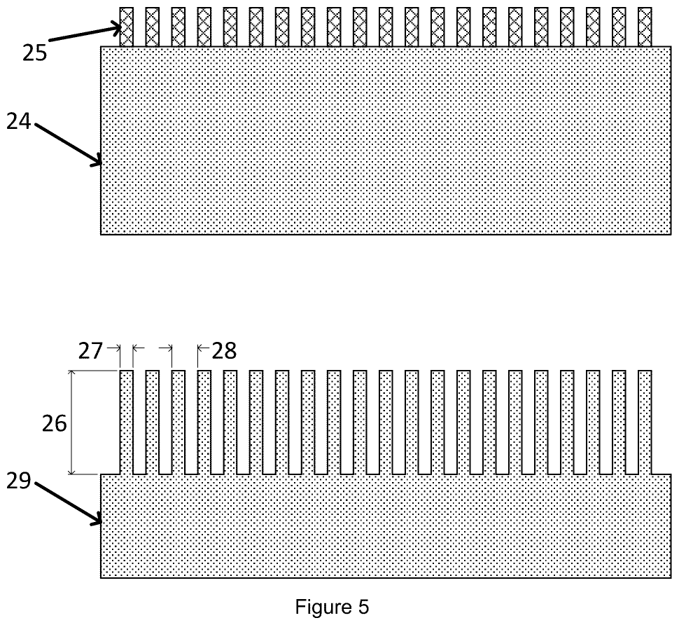

The details of the fabrication technique of one embodiment of the invention are shown in FIG. 5, which displays the component in cross section. The spatially variant 180 degree phase retarder consists of a glass substrate (24), which is modified by etching a meta-surface into the substrate. In some embodiments, the substrate is a fused silica (SiO₂) glass. A high selectivity mask (25) is applied to the surface using the Damascene method. The mask (25) consists of a material which is highly resistant to the plasma etching process used to create the pattern in the substrate, in some embodiments the mask (25) consists of Aluminum Oxide (Al₂O₃). The plasma etching process is then used to create grooves between the mask elements. The thickness of the mask is selected such that at the time required to etch the grooves into the substrate to the desired depth, the mask is also completely removed, leaving a pattern of ridges and grooves in the now modified substrate (29). The ridges have a large height (26) to width (27) aspect ratio, and a period (28) selected to provide the desired phase retardance.

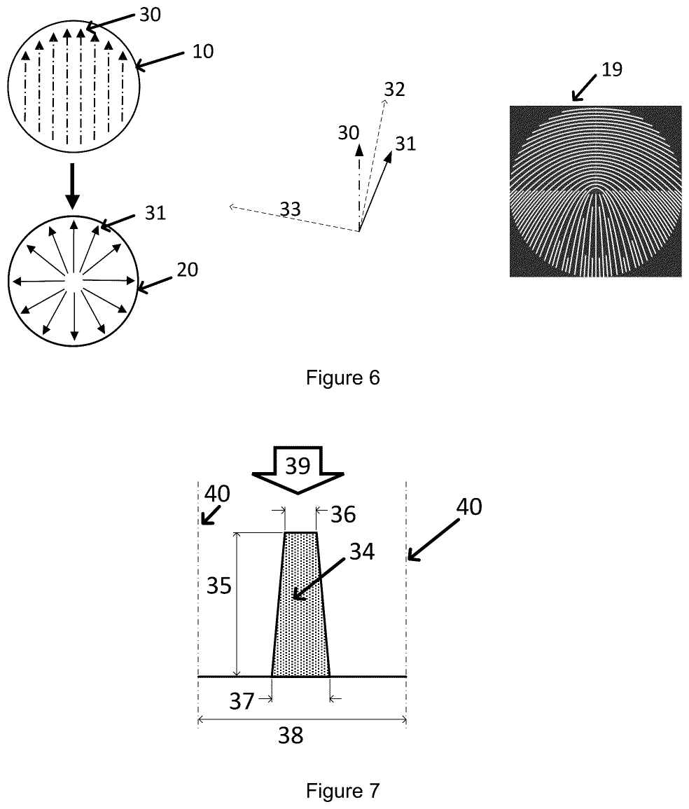

The purpose of the pattern of ridges and grooves is to create a material which has one value of the index of refraction for light with polarization parallel to the ridges and a different value for light with polarization perpendicular to the ridges. FIG. 6 illustrates the design process of the pattern of ridges. In one embodiment of the invention, the spatially variant 180 degree phase retarder converts incident, uniformly, linear polarized light (10) into linearly polarized light with a radial pattern of polarization (20). The polarization at each location in the beam is altered through the use a 180 degree phase retarder. Examining a single location of the incoming light, the polarization is shown vertically (30), it is desired to rotate this to an angle (31) which depends on the position in the beam. It is well established that a 180 degree phase retarder with the fast axis (32) placed at an angle (θ) relative to the incoming polarization (30) changes the polarization to an angle of −θ (31) relative to the fast axis. Using this relationship, the orientation of the phase retarder fast axis can be calculated over the area of the beam. Subwavelength ridge and groove structures have been shown to produce birefringent structures with the fast axis of the birefringence oriented perpendicular to the ridges and the slow axis parallel. The calculation of the spatial structure of the orientation of the phase retardance results in the pattern shown (19). Note that the pattern shows the orientation, while the actual size of the ridges is a fraction of the wavelength of the light.

In some embodiments of the invention, the nano-structure provides a transition region from the index of refraction of the ambient environment into the higher index of the glass substrate. This transition mitigates the usual Fresnel reflections which occur at a flat interface. The effect was optimized while maintaining the required 180 degree (π radian) phase retardance. FIG. 7 illustrates the desired geometry and the simulation results. A single ridge is shown in cross section (34) with a trapezoidal shape. The width of a period of a single ridge with the adjoining grove is shown (38) along with the period boundaries (40), this width was maintained constant in all geometries. Several different configurations for the height (35), width at the tip (36), and base width (37) were simulated. The simulations showed that a reflection coefficient of less than 0.2% is realized with an aspect ratio that has been demonstrated with the fabrication method previously described and shown in FIG. 5.

1. The method of mitigating thermal depolarization in laser systems comprising: a laser gain media with a known birefringence pattern; quantity two, spatially variant, optical phase retarders such that the first transforms a linearly polarized laser beam into a custom polarization pattern aligned with the slow axis of the birefringence of the gain media and the second converts the polarization back to the original state; and the method of placing one of the phase retarders on either side of the gain media.

2. The method of claim 1, wherein each of the two phase retarders consist of a glass substrate with a nano-structured meta-surface on one or both surfaces.

3. The method of claim 2, wherein the substrate is a glass transparent to the laser wavelength with a high damage threshold such as fused silica (SiO₂).

4. The method of claim 2, wherein the meta-surface is formed directly on the glass substrate using a high selectivity mask.

5. The method of claim 2, wherein the meta-surface consists of a pattern of ridges with a height to width aspect ratio greater than 20 to 1.

6. The method of claim 2, wherein the aspect ratio and duty cycle of the ridges produces a 180 degree phase retardance between the parallel and perpendicular polarization components of the incident laser light.

7. The method of claim 2, wherein the pattern of the ridges is designed to produce the desired polarization transformation.

8. The method of claim 2, wherein the shape and aspect ratio of the ridges is designed to reduce the fraction of incident laser light that is reflected.

9. An apparatus for: the mitigation of thermal depolarization in laser systems comprising: a laser gain media with a known birefringence pattern; quantity two, spatially variant, optical phase retarders in which the first transforms a linearly polarized laser beam into a custom polarization pattern aligned with the slow axis of the birefringence of the gain media and the second converts the polarization back to the original state; and the method of placing one of the phase retarders on either side of the gain media.

10. The apparatus of claim 9 wherein: phase retarders consist of a glass substrate with a nano-structured meta-surface on one or both surfaces.

11. The apparatus of claim 10 wherein: the substrate is a glass transparent to the laser wavelength with a high damage threshold such as fused silica (SiO₂).

12. The apparatus of claim 10 wherein: the meta-surface is formed directly on the glass substrate using a high selectivity mask.

13. The apparatus of claim 10 wherein: the meta-surface consists of a pattern of ridges with a height to width aspect ratio greater than 20 to 1.

14. The apparatus of claim 10 wherein: the aspect ratio and duty cycle of the ridges produces a 180 degree phase retardance between the parallel and perpendicular polarization components of the incident laser light.

15. The apparatus of claim 10 wherein: the pattern of the ridges is designed to produce the desired polarization transformation.

16. The apparatus of claim 10 wherein: the shape and aspect ratio of the ridges is designed to reduce the fraction of incident laser light that is reflected.
